(19) United States
(12) Patent Application Publication
(10) Pub. No.: US 2024/0065484 A1
(43) Pub. Date: Feb. 29, 2024

(54) STORAGE LID FOR A COUNTERTOP APPLIANCE

(71) Applicant: WHIRLPOOL CORPORATION, BENTON HARBOR, MI (US)

(72) Inventors: Yifan Wang, Benton Harbor, MI (US); Brandon Tyler Mock, St. Joseph, MI (US); Jiangang Guo, Foshan (CN); Yongjia Guo, Suizhou City (CN); Liqing Wang, Zhongshang City (CN); Haiqiang Zhang, Yunfu City (CN)

(73) Assignee: WHIRLPOOL CORPORATION, BENTON HARBOR, MI (US)

(21) Appl. No.: 18/272,291

(22) PCT Filed: Jan. 14, 2021
(86) PCT No.: PCT/CN2021/071692

§ 371 Date: Jul. 13, 2023

(51) Int. Cl. A47J 43/07; A47J 36/10

(52) U.S. Cl. CPC A47J 43/0716; A47J 36/10

(57) ABSTRACT

A storage lid for a countertop appliance includes a body that has a first surface and a second surface and includes a raised peripheral wall that is disposed around the first surface and a lid that is disposed around the second surface. An elongated handle extends outwardly from the first surface and defines a recessed channel along the second surface of the body. A tab is operably coupled to the raised peripheral wall of the body. A sealing member is disposed proximate to the lip of the body.

### BACKGROUND OF THE DISCLOSURE

The present disclosure generally relates to a countertop appliance, and more specifically, to a storage lid for a countertop appliance.

### SUMMARY OF THE DISCLOSURE

According to one aspect of the present disclosure, a countertop appliance includes a base. A housing is operably coupled to the base and defines an adapter aperture. The housing includes an adapter disposed within the adapter aperture. A storage lid is operably coupled to the housing. The storage lid includes a body that has a raised peripheral wall that defines a recessed portion and a lip proximate to the raised peripheral wall. The storage lid further includes an elongated handle that is operably coupled to the recessed portion of the body, a locking tab that extends outwardly from the raised peripheral wall, and a sealing member that is coupled to the lip of the body. A lid is selectively coupled to the storage lid and is operably coupled to the housing. The lid includes a locking feature that is selectively coupled to the locking tab of the storage lid.

According to another aspect of the present disclosure, a countertop appliance includes a housing that defines a cavity and has a bottom portion that defines an adapter aperture. A first lid is operably coupled to the housing. The first lid includes a body that has a first surface and a second surface, an elongated handle that extends outwardly from the first surface of the body and defines a recessed channel along the second surface of the body, and a locking tab that is operably coupled to the body. A second lid is operably coupled to the housing and is selectively coupled to the first lid.

According to yet another aspect of the present disclosure, a storage lid for a countertop appliance includes a body that has a first surface and a second surface and includes a raised peripheral wall that is disposed around the first surface and a lid that is disposed around the second surface. An elongated handle extends outwardly from the first surface and defines a recessed channel along the second surface of the body. A tab is operably coupled to the raised peripheral wall of the body. A sealing member is disposed proximate to the lip of the body.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a countertop appliance of the present disclosure;

FIG. 2 is a cross-sectional view of the countertop appliance of FIG. 1 taken along lines II-II;

FIG. 3 is a top perspective view of a storage lid and a housing of the present disclosure;

FIG. 4 is a an exploded bottom perspective view of the storage lid and the housing of FIG. 3 with an adaptor and a handle;

FIG. 5 is a top perspective view of a storage lid of the present disclosure;

FIG. 6 is an enlarged view of a housing, a storage lid, and a lid of the countertop appliance of FIG. 2 taken at area VI;

FIG. 7 is a top perspective view of a storage lid of the present disclosure with a sealing member removed;

FIG. 8 is a side elevational view of a storage lid of the present disclosure; and

FIG. 9 is a bottom perspective view of a storage lid of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a countertop appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

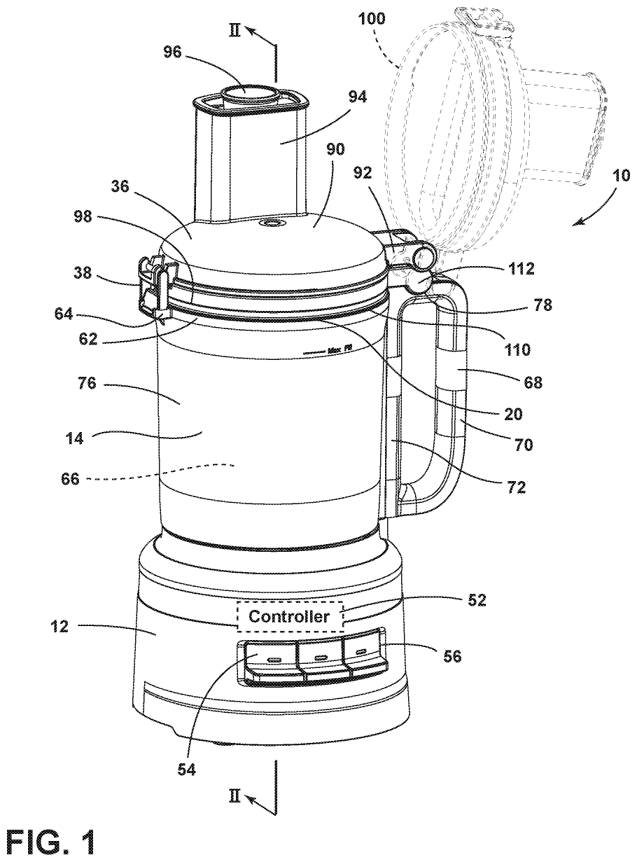

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

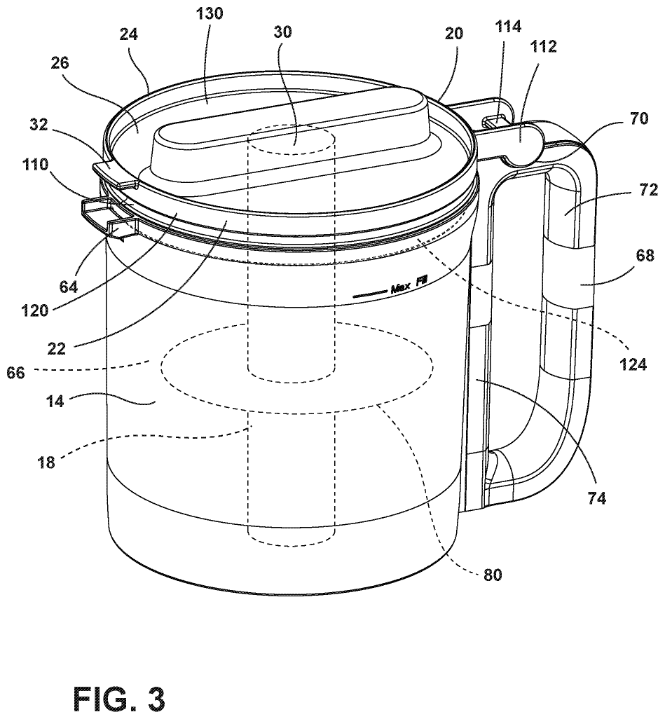

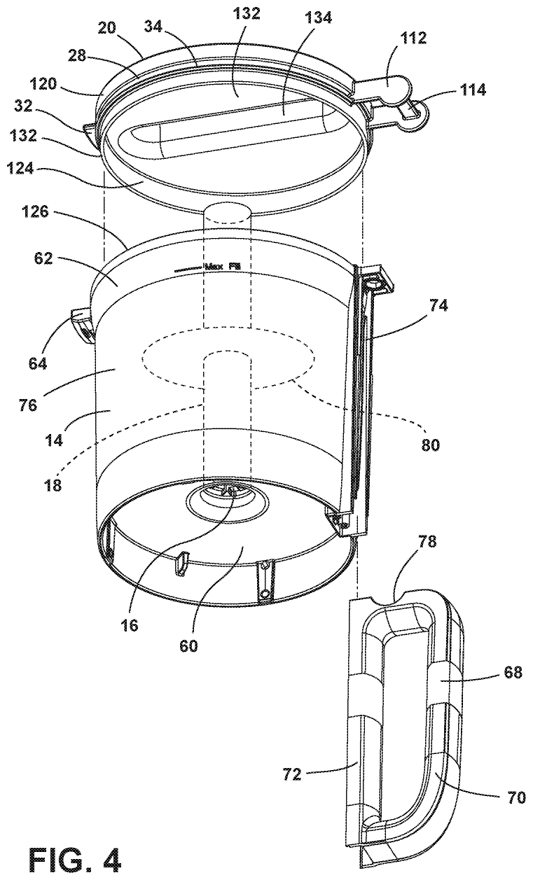

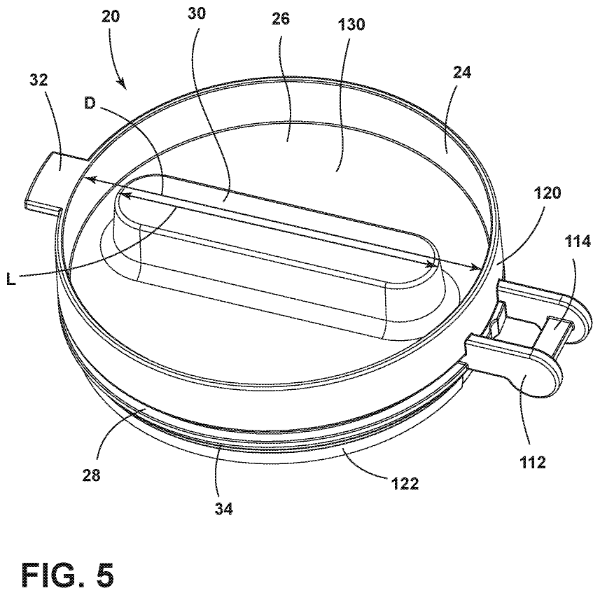

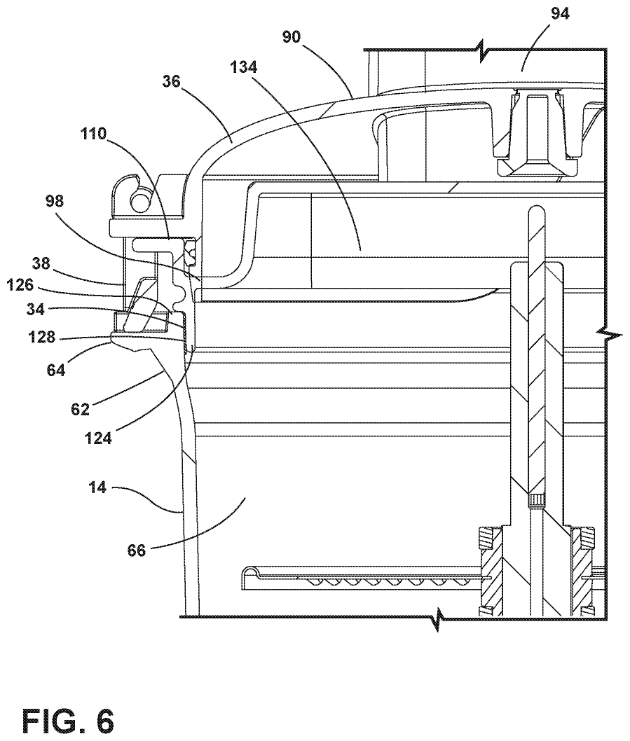

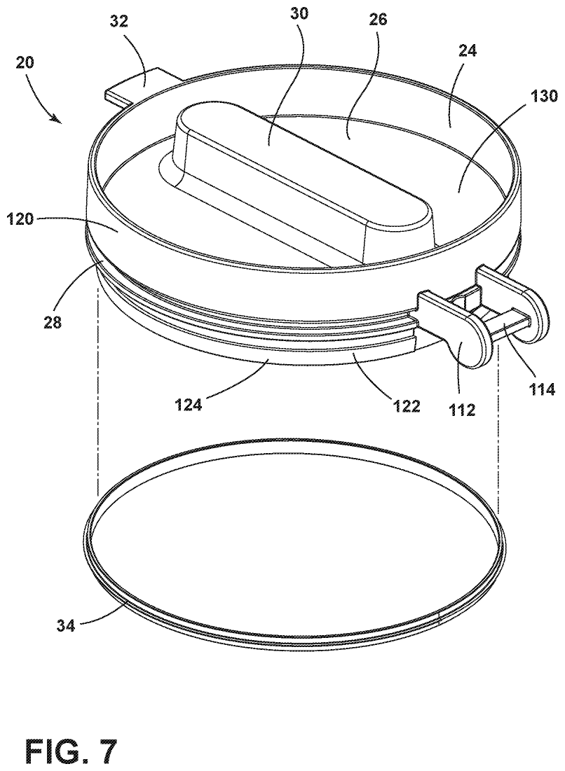

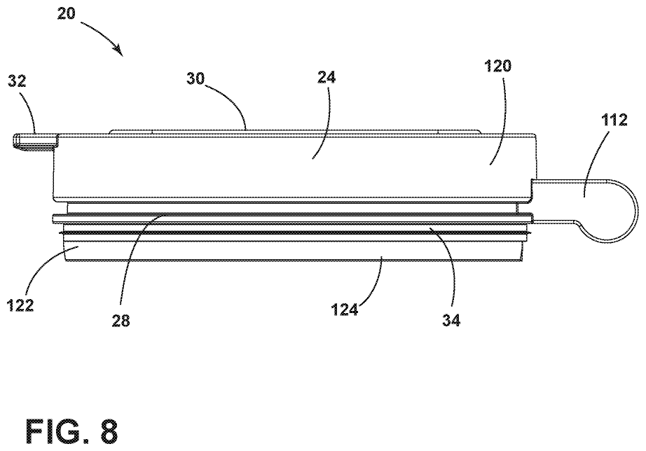

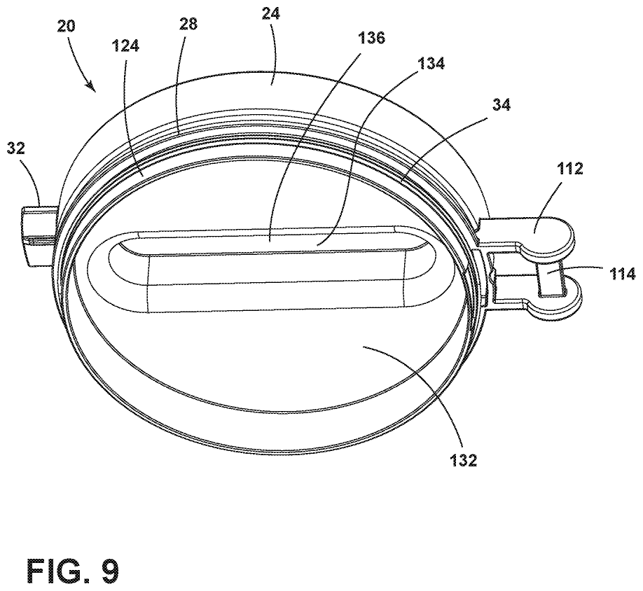

Referring to FIGS. 1-9, reference numeral 10 generally designates a countertop appliance that includes a base 12 and a housing 14 that is operably coupled to the base 12. The housing 14 defines an adapter aperture 16 and includes an adapter 18 that is disposed within the adapter aperture 16. A storage lid 20 is operably coupled to the housing 14. The storage lid 20 includes a body 22 having a raised peripheral wall 24 that defines a recessed portion 26 and a lip 28 proximate to the raised peripheral wall 24. An elongated handle 30 is operably coupled to the recessed portion 26 of the body 22. A locking tab 32 extends outwardly from the raised peripheral wall 24, and a sealing member 34 is coupled to the lip 28 of the body 22. A lid 36 is selectively coupled to the storage lid 20 and is operably coupled to the housing 14. The lid 36 includes a locking feature 38 that is selectively coupled to the locking tab 32 of the storage lid 20.

Referring now to FIGS. 1-4, the countertop appliance 10 is illustrated as a food processor. It is also contemplated that the countertop appliance 10 may include other countertop appliances including, but not limited to, stand mixers, blenders, and other countertop appliances generally known in the art that may utilize the lid 36 and the storage lid 20. It is generally contemplated that the storage lid 20 may be referred to as a first lid and the lid 36 may be referred to as a second lid. As mentioned above, the countertop appliance 10 includes the housing 14, which is typically disposed on and operably coupled to the base 12. The base 12 includes a motor 50 that is operably coupled to a controller 52 and tactile indicia 54, illustrated as buttons on a user interface 56 of the base 12. The tactile indicia 54 can typically control the speed and other functionality of the countertop appliance 10, such as pulse functions and other typical functions of a countertop appliance known in the art. The base 12 also includes an attachment feature 58, which is operably coupled to the motor 50 to engage the adapter 18 disposed within the housing 14. It is generally contemplated that the housing 14 is operably coupled to the base 12 via the attachment feature 58, and the adapter 18 is operably coupled to the attachment feature 58, which selectively operates the adapter 18 within the housing 14.

As set forth herein, the housing 14 includes the adapter 18 which extends through the adapter aperture 16 defined by a bottom portion 60 of the housing 14. It is generally contemplated that the adapter aperture 16 provides access into the housing 14 via the bottom portion 60 when the adapter 18 is removed from the housing 14. The housing 14 also includes an upper edge 62 and a flange 64 outwardly extending from the upper edge 62. The flange 64 may function as a spout to direct the contents from the housing 14. The flange 64 also provides an attachment point for the lid 36 to securely couple to the housing 14 via the locking feature 38. The locking feature 38 is illustrated as having a ring-shaped configuration and is configured to be disposed around the flange 64 during operation of the countertop appliance 10. As will be described in more detail below, the locking feature 38 can also be operably coupled to the locking tab 32 of the storage lid 20. The housing 14 also defines a cavity 66 in which the adapter 18 is disposed, as described in more detail below. The cavity 66 can be at least partially exposed via the adapter aperture 16 when the adapter 18 is removed from the housing 14. The user can deposit food items into the cavity 66 via the lid 36, described below.

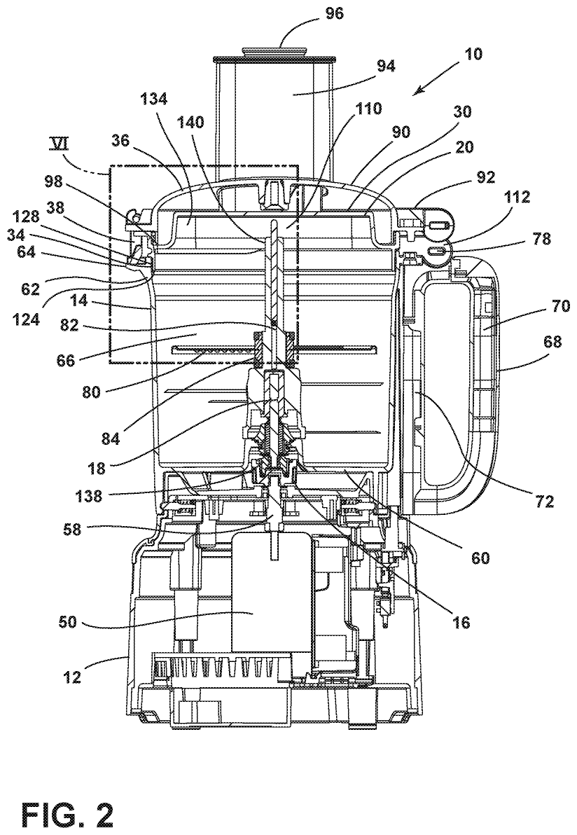

With further reference to FIGS. 1-4, a handle 68 includes a grasping portion 70 and a coupling portion 72. The coupling portion 72 of the handle 68 is operably coupled to the housing 14 along an attachment rail 74 disposed along an outer surface 76 of the housing 14. The handle 68 is illustrated as having a D-shaped configuration and defines an attachment aperture 78, described further below. It is also contemplated that the handle 68 may have alternate configurations than that depicted, such that the handle 68 may define the attachment aperture 78 while having an L-shaped configuration, a C-shaped configuration, and/or other handle configurations generally known in the art. As mentioned above, the adapter 18 is disposed within the cavity 66 of the housing 14. The adapter 18 may include an attachment 80 operably coupled to a shaft 82 of the adapter 18. The attachment 80 may include, but is not limited to, a plate, a blade, a grater, and other attachments generally known in the art. It is generally contemplated that the shaft 82 may define at least one projection 84 that is configured to selectively couple to at least one of the attachments 80 to retain the selected attachment 80 at a predetermined position within the cavity 66 of the housing 14. As illustrated in FIG. 2, the adapter 18 generally extends above the upper edge 62 of the housing 14, such that the adapter 18 may be said to be proximate to the lid 36 of the countertop appliance 10.

With further reference to FIGS. 1-4, the lid 36 includes a cover portion 90, the locking feature 38, and a coupling feature 92 outwardly extending from the cover portion 90. The lid 36 also includes a chute 94, through which a user may deposit food items into the cavity 66 of the housing 14. It is generally contemplated that the chute 94 also includes a pusher 96 that is selectively disposed within the chute 94 to close the chute 94 relative to the external environment. The pusher 96 is selectively removable from the chute 94 so the user may remove the pusher 96 to deposit food items through the chute 94 and into the cavity 66 of the housing 14. Thus, the chute 94 advantageously allows the lid 36 to remain coupled to the housing 14 in a closed position 98 while still providing access to the cavity 66.

It is generally contemplated that the lid 36 is operably coupled to the housing 14 via the outwardly extending flange 64 of the housing 14 by operably coupling the locking feature 38 to the flange 64 of the housing 14, as mentioned above, to define the closed position 98. It is also contemplated that the coupling feature 92 of the lid 36 may be rotatably coupled to the handle 68 within the attachment aperture 78. The coupling feature 92 of the lid 36 may rotate within the attachment aperture 78 to translate the lid 36 from the closed position 98 into an open position 100. The open position 100 of the lid 36 provides access to the cavity 66 of the housing 14. In the open position 100, the user may adjust, remove, or otherwise articulate the adapter 18 within the cavity 66 of the housing 14. By way of example, and not limitation, the user may exchange or otherwise change the attachment 80 coupled to the shaft 82 of the adapter 18, while the lid 36 is in the open position 100.

With reference now to FIGS. 2-6, the storage lid 20 is operably coupled to the housing 14 and is selectively coupled to the lid 36 to define a storage position 110 of the countertop appliance 10. The lid 36 can be either coupled to the storage lid 20 via the locking fastener 38 or removed from the storage lid 20 and the housing 14 in the storage position 110. Whether the lid 36 is coupled to the storage lid 20 depends on the user's storage desires. For example, if the user is storing the food items in an appliance, the user typically will remove the lid 36 to utilize the storage lid 20 and the housing 14 as a single unit. The user may store the lid 36 along with the storage lid 20 and the housing 14 when the user is storing the entirety of the countertop appliance 10.

It is generally contemplated that the storage position 110, while a separate position, may be defined by the closed position 98 mentioned above. The storage lid 20 includes a retention feature 112 that is operably coupled to the handle 68 at the attachment aperture 78. As mentioned above, the storage lid 20 includes the body 22, which defines the raised peripheral wall 24 and the recessed portion 26. The elongated handle 30 is disposed along the recessed portion 26 of the body 22 and is generally surrounded by the raised peripheral wall 24. Stated differently, the elongated handle 30 outwardly extends from the recessed portion 26 of the body 22, which is defined, at least in part, by the raised peripheral wall 24. The elongated handle 30 can extend above the raised peripheral wall 24, which advantageously accommodates the adapter 18, as described below. It is generally contemplated that the elongated handle 30 includes a length L and extends along a portion of a diameter D of the body 22 of the storage lid 20.

The storage lid 20 also includes the locking tab 32, which outwardly extends from the raised peripheral wall 24 and is generally disposed above the outwardly extending flange 64 of the housing 14. On an opposing side of the storage lid 20, the retention feature 112 of the storage lid 20 is operably coupled to the attachment aperture 78 defined by the handle 68. The retention feature 112 includes a crossbar 114 that extends over the attachment aperture 78. It is generally contemplated that the crossbar 114 of the retention feature 112 may engage the handle 68 to retain the storage lid 20 in the open position 100 (FIG. 1). It is generally contemplated that the storage lid 20 may be at an approximately 90-degree angle in the open position 100 (FIG. 1). However, it is also contemplated that the storage lid 20 may be positioned at an angle greater than 90-degrees and/or less than 90-degrees.

With further reference to FIGS. 2-6, the storage lid 20 is selectively coupled to the housing 14 and is operable between the storage position 110 and the open position 100 (FIG. 1), mentioned above. It is generally contemplated that the locking feature 38 of the lid 36 is operably coupled to the locking tab 32 of the storage lid 20 in the storage position 110 of each of the storage lid 20, the lid 36, and the housing 14. Stated differently, the countertop appliance 10 may be at least partially stored when the housing 14, the storage lid 20, and the lid 36 are in the storage position 110. Additionally or alternatively, the storage position 110 can be defined by the storage lid 20 being operably coupled to the housing 14 with the lid 36 being selectively removed from both the storage lid 20 and the housing 14. As described in more detail below, it is also contemplated that the adapter 18 can be disposed within the housing 14 in the storage position 110 of the housing 14 and the storage lid 20.

Referring now to FIGS. 2 and 5-9 and as mentioned above, the body 22 of the storage lid 20 includes an upper portion 120 and a lower portion 122, which are generally defined by either side of the lip 28. The lip 28 circumferentially extends from the lower portion 122, and a lower wall 124 extends from the lip 28. The lower wall 124 is configured to generally extend into the housing 14 proximate to the upper edge 62 of the housing 14. Stated differently, the lower wall 124 overlaps with the upper edge 62 of the housing 14, and the lip 28 selectively engages a top edge 126 of the housing 14 in the storage position 110. The sealing member 34 is operably coupled to and disposed around the lower wall 124 of the storage lid 20 and engages the lip 28. The lip 28 is configured to be disposed on the top edge 126 of the housing 14 to generally cover a space 128 between the lower wall 124 and the upper edge 62 of the housing 14.

The sealing member 34 is disposed between the lower wall 124 and the upper edge 62 to define the seal, which closes off the space 128 between the lower wall 124 and the upper edge 62. As mentioned above, the lip 28 extends across the space 128 to further close off the space 128 between the lower wall 124 and the upper edge 62 in addition to the sealing member 34. The lip 28 and the sealing member 34 are operably coupled to the upper edge 62 of the housing 14 in the storage position 110. The sealing member 34 circumferentially engages the upper edge 62 of the housing 14 to define the seal between the storage lid 20 and the housing 14, which may retain the overall freshness of the food items disposed within the housing 14. It is generally contemplated that the sealing member 34 may be comprised of a rubber seal, silicone, and/or other materials generally known in the art to form a seal.

As generally mentioned above, the storage lid 20 also includes the locking tab 32, which outwardly extends from the raised peripheral wall 24. The locking tab 32 is configured to be coupled with the locking feature 38 of the lid 36 in the storage position 110, as mentioned above. The locking feature 38 is illustrated with a ring-like configuration, as mentioned above, through which the locking tab 32 may extend in the storage position 110. The locking tab 32 and the locking feature 38 operably couple the lid 36 to the storage lid 20, which maximizes the storage abilities of the countertop appliance 10. The countertop appliance 10 can be stored with both the storage lid 20 and the lid 36 coupled to the housing 14 to maximize storage space of the countertop appliance 10.

With further reference to FIGS. 2 and 5-9, the recessed portion 26 of the body 22 includes a first surface 130 and a second surface 132. The first surface 130 is recessed relative to the raised peripheral wall 24, and the second surface 132 is recessed relative to the lower wall 124. Stated differently, the recessed portion 26 is defined as being recessed relative to both the raised peripheral wall 24 and the lower wall 124. The elongated handle 30 can be disposed proximate to the raised peripheral wall 24 along the first surface 130 of the recessed portion 26. It is generally contemplated that the elongated handle 30 may be integrally formed with the recessed portion 26. Stated differently, the elongated handle 30 is contemplated to be integrally formed with the body 22, such that as the elongated handle 30 outwardly extends from the recessed portion 26. Additionally or alternatively, the elongated handle 30 may be coupled to the recessed portion of the body 22.

The elongated member 30 defines a recessed channel 134 along the second surface 132 of the recessed portion 26. The recessed channel 134 is defined along the second surface 132, such that the recessed channel 134 and the elongated handle 30 can be integrally formed from the second surface 132. It is generally contemplated that the recessed channel 134 of the elongated handle 30 is configured to receive the adapter 18 disposed within the cavity 66 of the housing 14. The recessed channel 134 advantageously provides a receiving space 136 for the adapter 18, such that the adapter 18 may remain within the housing 14 in the storage position 110. Specifically, the adapter 18 includes a first end 138 disposed within the adapter aperture 16 of the housing 14 and a second end 140 selectively received within the receiving space 136 of the recessed channel 134. In such a configuration, the user may directly store the housing 14 and the storage lid 20, without removing the adapter 18. The user may thus maintain the contents relatively undisturbed within the housing 14 in the storage position 110.

With further reference to FIGS. 1-9, the user can utilize the housing 14 during the preparation and storage of a food item, which minimizes the number of devices the user utilizes during a cooking process. For example, the user can prepare food items within the countertop appliance 10 and directly store the prepared food items within the housing 14 by attaching the storage lid 20. The recessed channel 134 of the elongated handle 30 advantageously accommodates the adapter 18 within the receiving space 136. Thus, the adapter 18 can remain within the housing 14 if the user utilizes the storage lid 20 to at least temporarily store items within the housing 14. The adapter 18 closes off the adapter aperture 16, so the user can minimize the number of items used during preparation of a food item. The storage lid 20 maximizes the ability to use a minimal number of preparation items by accommodating the adapter 18 during storage of food items within the housing 14. Further, the configuration of the recessed channel 134 of the elongated handle 30 and the adapter 18 maximize the storage options for the countertop appliance 10 as a whole.

The user can neatly store all the features of the countertop appliance 10 in one space as the adapter 18 can remain within the housing 14 with any of the attachments 80. The storage lid 20 accommodates the height of the adapter 18. In addition, the storage lid 20 provides an attachment point for the lid 36 via coupling the locking feature 38 to the locking tab 32. Thus, the user can store all of the components of the countertop appliance 10, including both the lid 36 and the storage lid 20, in order to maximize the user's storage space.

The invention disclosed herein is further summarized in the following paragraphs and is further characterized by combinations of any and all of the various aspects described therein.

According to one aspect of the present disclosure, a countertop appliance includes a base. A housing is operably coupled to the base and defines an adapter aperture. The housing includes an adapter disposed within the adapter aperture. A storage lid is operably coupled to the housing. The storage lid includes a body that has a raised peripheral wall that defines a recessed portion and a lip proximate to the raised peripheral wall. The storage lid further includes an elongated handle that is operably coupled to the recessed portion of the body, a locking tab that extends outwardly from the raised peripheral wall, and a sealing member that is coupled to the lip of the body. A lid is selectively coupled to the storage lid and is operably coupled to the housing. The lid includes a locking feature that is selectively coupled to the locking tab of the storage lid.

According to another aspect, a housing further includes a handle that defines an attachment aperture. A storage lid further includes a retention feature that is operably coupled to the handle via the attachment aperture.

According to another aspect, a sealing member of a storage lid is operably coupled to an upper edge of a housing.

According to another aspect, an elongated handle defines a recessed channel.

According to another aspect, an adapter has a first end and a second end. The first end is disposed within an adapter aperture and the second end is selectively disposed within a recessed channel of an elongated channel.

According to another aspect, a locking feature of a lid is operably coupled to a locking tab of a storage lid in a storage position of each of the storage lid, the lid and a housing.

According to another aspect, an adapter is disposed within a housing in a storage position.

According to another aspect of the present disclosure, a countertop appliance includes a housing that defines a cavity and has a bottom portion that defines an adapter aperture. A first lid is operably coupled to the housing. The first lid includes a body that has a first surface and a second surface, an elongated handle that extends outwardly from the first surface of the body and defines a recessed channel along the second surface of the body, and a locking tab that is operably coupled to the body. A second lid is operably coupled to the housing and is selectively coupled to the first lid.

According to another aspect, a body of a first lid further includes a raised peripheral wall and a lip. A first surface is a recessed surface that is defined by the raised peripheral wall.

According to another aspect, a first lid further includes a sealing member that is proximate to a lip of a body. A sealing member is operably and selectively coupled to a housing.

According to another aspect, a first lid includes a lower wall that extends into a cavity of a housing. A sealing member is disposed on the lower wall.

According to another aspect, a second lid includes a locking feature that is operably coupled to a locking tab in a storage position of both a first lid and the second lid.

According to another aspect, an adapter is disposed within a cavity of a housing. The adapter is selectively disposed within a recessed channel of an elongated handle in a storage position of a first lid.

According to another aspect, a recessed channel defines a receiving space. An adapter is selectively disposed within the receiving space of the recessed channel.

According to yet another aspect of the present disclosure, a storage lid for a countertop appliance includes a body that has a first surface and a second surface and includes a raised peripheral wall that is disposed around the first surface and a lid that is disposed around the second surface. An elongated handle extends outwardly from the first surface and defines a recessed channel along the second surface of the body. A tab is operably coupled to the raised peripheral wall of the body. A sealing member is disposed proximate to the lip of the body.

According to another aspect, a first surface of a body comprises a recessed portion that is defined by a raised peripheral wall. The recessed portion includes a first surface and a second surface.

According to another aspect, an elongated handle extends above a raised peripheral wall of a body.

According to another aspect, an elongated handle is integrally formed with a first surface of a body.

According to another aspect, a storage lid further includes a retention feature that extends from a raised peripheral wall and a lip of a body.

According to another aspect, a storage lid further includes a lower wall that extends from a lip. A sealing member is operably coupled to the lower wall.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1-20. (canceled)

21. A countertop appliance, comprising:
a base;
a housing operably coupled to the base and defining an adapter aperture, the housing including an adapter disposed within the adapter aperture;
a storage lid operably coupled to the housing, the storage lid including:
a body having a raised peripheral wall that defines a recessed portion and a lip proximate to the raised peripheral wall;
an elongated handle operably coupled to the recessed portion of the body;
a locking tab extending outwardly from the raised peripheral wall; and
a sealing member coupled to the lip of the body; and
a lid selectively coupled to the storage lid and operably coupled to the housing, the lid including a locking feature that is selectively coupled to the locking tab of the storage lid.

22. The countertop appliance of claim 21, wherein the housing further includes a handle that defines an attachment aperture, and wherein the storage lid further includes a retention feature operably coupled to the handle via the attachment aperture.

23. The countertop appliance of claim 21, wherein the sealing member of the storage lid is operably coupled to an upper edge of the housing.

24. The countertop appliance of claim 21, wherein the elongated handle defines a recessed channel.

25. The countertop appliance of claim 24, wherein the adapter has a first end and a second end, and wherein the first end is disposed within the adapter aperture and the second end is selectively disposed within the recessed channel of the elongated handle.

26. The countertop appliance of claim 21, wherein the locking feature of the lid is operably coupled to the locking tab of the storage lid in a storage position of each of the storage lid, the lid, and the housing.

27. The countertop appliance of claim 26, wherein the adapter is disposed within the housing in the storage position.

28. A countertop appliance, comprising:
a housing defining a cavity and having a bottom portion that defines an adapter aperture;
a first lid operably coupled to the housing, the first lid including:
a body having a first surface and a second surface;
an elongated handle extending outwardly from the first surface of the body and defining a recessed channel along the second surface of the body; and
a locking tab operably coupled to the body; and
a second lid operably coupled to the housing and selectively coupled to the first lid.

29. The countertop appliance of claim 28, wherein the body of the first lid further includes a raised peripheral wall and a lip, and wherein the first surface is a recessed surface defined by the raised peripheral wall.

30. The countertop appliance of claim 29, wherein the first lid further includes a sealing member proximate to the lip of the body, and wherein the sealing member is operably and selectively coupled to the housing.

31. The countertop appliance of claim 29, wherein the first lid includes a lower wall extending into the cavity of the housing, and wherein the sealing member is disposed on the lower wall.

32. The countertop appliance of claim 28, wherein the second lid includes a locking feature operably coupled to the locking tab in a storage position of both of the first lid and the second lid.

33. The countertop appliance of claim 32, further comprising:
an adapter disposed within the cavity of the housing, and wherein the adapter is selectively disposed within the recessed channel of the elongated handle in the storage position of the first lid.

34. The countertop appliance of claim 33, wherein the recessed channel defines a receiving space, and wherein the adapter is selectively disposed within the receiving space of the recessed channel.

35. A storage lid for a countertop appliance, comprising:
a body having a first surface and a second surface and including a raised peripheral wall disposed around the first surface and a lip disposed around the second surface;
an elongated handle extending outwardly from the first surface and defining a recessed channel along the second surface of the body;
a tab operably coupled to the raised peripheral wall of the body; and
a sealing member disposed proximate to the lip of the body.

36. The storage lid of claim 35, wherein the first surface of the body comprises a recessed portion defined by the raised peripheral wall, and wherein the recessed portion includes the first surface and the second surface.

37. The storage lid of claim 35, wherein the elongated handle extends above the raised peripheral wall of the body.

38. The storage lid of claim 35, wherein the elongated handle is integrally formed with the first surface of the body.

39. The storage lid of claim 35, further comprising:
a retention feature extending from the raised peripheral wall and the lip of the body.

40. The storage lid of claim 35, further comprising:
a lower wall extending from the lip, wherein the sealing member is operably coupled to the lower wall.
